(19) United States
(12) Patent Application Publication
(10) Pub. No.: US 2009/0214224 A1
(43) Pub. Date: Aug. 27, 2009

(54) METHOD AND APPARATUS FOR COHERENT ANALOG RF PHOTONIC TRANSMISSION

(75) Inventors: Pak Shing Cho, Gaithersburg, MD (US); Yaakov Achiam, Rocikville, MD (US)

Correspondence Address: CELIGHT, INC., 12200 TECH RD., SILVER SPRING, MD, 20904, US

(73) Assignee: CeLight, Inc.

(21) Appl. No.: 12/435,151

(22) Filed: May 4, 2009

Related U.S. Application Data
(63) Continuation-in-part of application No. 11/695,920, filed on Apr. 3, 2007.

(51) Int. Cl. H04B 10/04

(52) U.S. Cl. 398/188

(57) ABSTRACT

A system for high fidelity analog RF photonic communications is disclosed wherein linear phase modulation and linear coherent demodulation is included. A single optical beam with a phase-modulated signal optical carrier combined with an orthogonally polarized reference unmodulated optical carrier is transmitted simultaneously. At the receiver, the polarization of the reference carrier is transform to match that of the signal followed by coherent detection. An in-phase and quadrature-phase component of the homodyne signal is generated where they are digitized and processed to recover the original RF signal.

### FIELD OF INVENTION

This invention relates generally to analog RF photonic communications with linear phase modulation and linear coherent demodulation.

### BACKGROUND

Analog RF photonics communication requires high linearity to meet the stringent requirements on dynamic range and signal-to-noise ratio for applications such as communications, radar, and electronic warfare. Conventional approach for analog RF photonics employs intensity modulation (IM) to transfer the baseband RF signal onto an optical carrier. This can be achieved via directly modulated semiconductor laser or external modulator such as semiconductor electro-absorption modulator (EAM) or electro-optic lithium niobate Mach-Zehnder modulator (MZM). High-speed modulation and low noise is difficult to achieve with direct modulation of laser diodes. External modulation using an EAM or a quadrature-biased MZM provides high-speed operation without additional optical noise. However, the transfer response of EAM and MZM is not truly linear. The transmission of EAM depends exponentially on the applied voltage while MZM has a nonlinear sinusoidal transfer response. The nonlinear response produces undesirable harmonic distortion. To minimize the harmonic distortion, the modulation depth must be limited for intensity modulation reducing the dynamic range. Optical amplifiers can provide some degree of improvement in the modulation depth but the cost as well as added amplified spontaneous emission optical noise must be considered. Thus, in analog links employing IM using MZM the nonlinear transfer function usually dictates the linearity of the link. In addition, for analog photonic transmission in optical fiber IM gives rise to signal distortion as a result of fiber nonlinearities. This is because most nonlinear effects in fiber are dependent on the instantaneous optical power.

Optical phase modulation, in contrast to IM, can generate practically unlimited modulation depth with high linearity. Optical phase modulators that exhibit the linear electro-optic effect, e.g., lithium niobate provide a true linear transfer response where the optical phase modulation is directly proportional to the signal voltage applied to the electro-optic material. At the receiver, optical mixing via coherent detection is required to convert the phase modulated optical signal to an amplitude modulated base-band RF signal. This requires, for example, a local laser at the receiver that coherently interfered with the optical signal at a photodetector. Optical phase-locked loop (OPLL) that performs optical phase tracking between the signal and reference optical carrier is needed to obtain a stable output signal. Fast OPLL with a small loop delay (e.g., subnanosecond) or a large loop bandwidth is required to ensure that phase fluctuations of the optical sources are accurately cancelled. In addition, narrow-linewidth transmitting laser and local laser at the receiver are usually required. Such a fast OPLL and narrow-linewidth lasers place limits on the performance and incur high cost of the RF photonic system. Furthermore, the standard optical mixing technique has a nonlinear sinusoidal response which limits the link performance such as the dynamic range.

There is a need in RF photonic communications system with a true linear modulation and a true linear demodulation response that preserve the fidelity of the demodulated RF signal but without the need of a complex high-speed OPLL and narrow-linewidth laser sources.

### SUMMARY OF THE INVENTION

In accordance with the teachings of the present invention, a high fidelity analog RF photonic system with a true linear modulation and demodulation response that does not require an OPLL or narrow-linewidth lasers is disclosed. The analog RF photonic system includes a transmitter having a linear RF-to-optical conversion unit that generates an optical beam with orthogonally polarized signal and reference carriers and a receiver having a coherent demodulator and a signal recovery unit.

Two portions of a laser beam with orthogonal polarization states are transmitted towards the receiver. The first portion is modulated with a RF or microwave input signal to produce a phase modulated optical signal. The receiver aligns the polarization states of the beam portion and mixes incoming the first and the second portions of the light beam producing output mixed beams that are detected by a set of photodiodes followed by a digital signal processing (DSP) unit. In the preferred embodiment the beams are mixed in 90-degrees optical hybrid, and output mixed beams are detected by two pairs of balanced photodiodes.

A half-wave (λ/2) plate is used in one embodiment for polarization rotation of the second portion of the light beam relative the first portion of the light beam. A polarization beam combiner is used to combine the first and second portions of the light beam prior to transmitting them to the receiver. At the receiver side the system includes a polarization beam splitter to separate the first and the second portions of the light beam and a polarization rotator to align the polarization states of the first and the second portions of the light beam.

Alternatively, an initial optical beam from a laser may be split into the first portion and the second portion propagating in a first and a second polarization-maintaining (PM) optical fibers with the directions of the stress rod of the first and the second PM fibers differ by 90°.

In one embodiment the initial undivided optical beam enters the phase modulator having a polarization state at a 45° angle relative to the optical axis of the optical phase modulator.

In one embodiment, the first portion of the light beam comprise OFDM (orthogonal frequency division multiplexed) signal with a plurality of orthogonal frequency subcarriers encoded with the RF or microwave signal using the phase modulator, and the DSP unit performs Fast Fourier Transformer operation to separate the frequency subcarrier signals and recover RF and microwave signal from each subcarrier.

Yet another object of the present invention is a method of a RF or microwave photonic transmission, comprising: phase modulating a first portion of a light beam with the RF or microwave input signal to produce a phase modulated optical signal and transmitting the first portion of the light beam to a receiver along with a second portion of the light beam. At the receiver the polarization states of the beam portions are aligned, and they are mixed producing output mixed beams that are detected by a set of photodiodes followed by a DSP unit. The DSP unit outputs an output signal for further processing or display.

In the preferred embodiment, the modulator operation is linear. The beams mixing is performed in a 90-degrees optical hybrid connected to a pair of balanced detectors.

The signal transmission may be performed in fiber, free space, air or water.

### BRIEF DESCRIPTION OF THE DRAWINGS

The present invention may be understood by reference to the following detailed description of the preferred embodiment of the present invention, illustrative examples of specific embodiments of the invention and the appended figures in which:

FIG. 1. A schematic block diagram of an analog RF photonic system according to an embodiment of the present invention.

FIG. 2. An embodiment of the RF-to-optical conversion unit producing orthogonally polarized signal and reference using a half-wave plate (λ/2) and a polarization beam combiner (PBC).

FIG. 3. An embodiment of the RF-to-optical conversion unit producing orthogonally polarized signal and reference using polarization-maintaining (PM) fibers and a polarization beam combiner (PBC). PANDA type PM fibers are shown.

FIG. 4. A preferred embodiment of the RF-to-optical conversion unit producing orthogonally polarized signal and reference by launching the input laser at a 45° angle relative to the optical axis of the optical phase modulator. No PBC is required.

FIG. 5. A preferred embodiment of the coherent demodulator producing I (in-phase) and Q (quadrature-phase) signals that contains the RF signal. PMS: polarization mode splitter. PT: polarization transformer. No local laser or OPLL is required.

### DETAILED DESCRIPTION OF THE PREFERRED EMBODIMENT

The foregoing description of a preferred embodiment of the invention has been presented for purposes of illustration and description. It is not intended to be exhaustive or to limit the invention to the precise form disclosed, and obviously many modifications and variations are possible in the light of the above teaching.

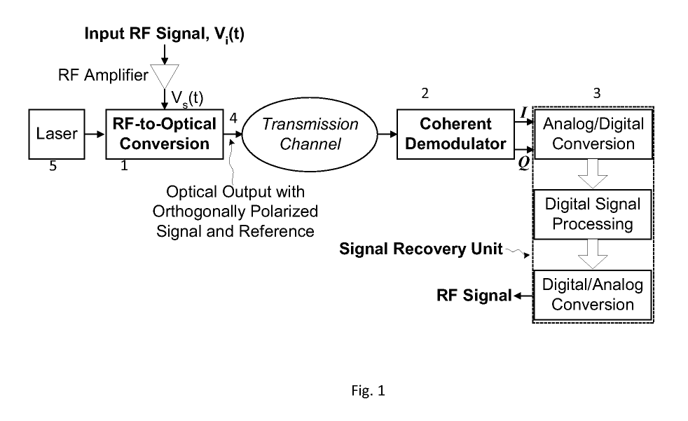

FIG. 1 shows a schematic block diagram of an analog RF photonic communications system according to an embodiment of the present invention. The optical carrier signal is generally transmitted along a transmission channel to a receiver where it is demodulated to recover the RF data. The transmission channel may include optical fibers, line-of-sight (atmosphere or space) or non-line-of-sight free-space (atmosphere only), and underwater environment.

Key components of the embodiment are the RF-to-optical conversion unit 1, the coherent demodulator 2, and the signal recovery unit 3 (FIG. 1). Details of these key components are described next.

The output 4 of the RF-to-optical conversion unit is composed of a phase-modulated optical carrier (signal) and an unmodulated optical carrier (reference), both originated from the same laser. The signal portion of the optical carrier is phase modulated according to the RF signal, V_{S}(t). The reference portion of the optical carrier, on the other hand, is not modulated and does not carry any information. The signal and reference are orthogonally polarized and they are transmitted simultaneously to the channel. Since the two are transmitted simultaneously through the channel in a single beam both suffer the same phase fluctuation from the channel. Furthermore, since the signal and reference originated from the same laser source 5 both inherit identical phase and amplitude noise from the laser. Therefore, unlikely conventional coherent detection no optical phase tracking such as OPLL nor narrow-linewidth laser sources is required in the present embodiment.

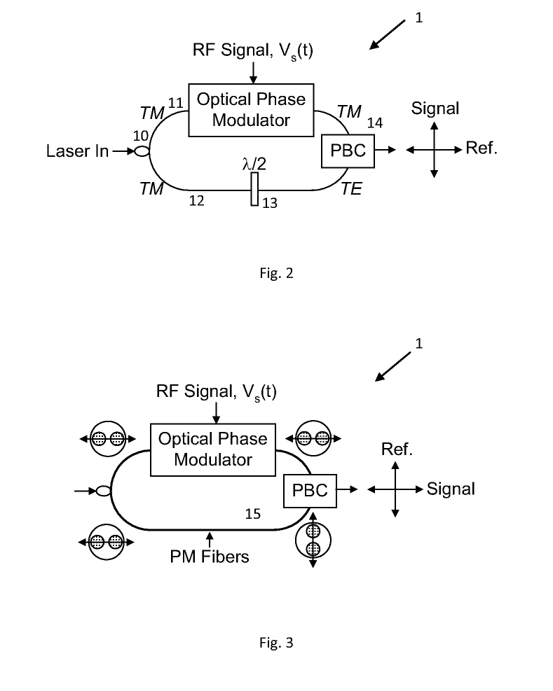

FIG. 2 shows one embodiment of the RF-to-optical conversion unit 1 that produces the orthogonally polarized signal and reference optical carriers. The input laser power is divided into two branches in splitter 10 where the upper one 11 is phase-modulated and linearly polarized to, e.g. TM. The lower branch 12 with the unmodulated reference carrier has a half-wave plate (λ/2) 13 to rotate the reference carrier polarization by 90° to TE. The signal and reference optical carriers are combined into a single beam via a polarization beam combiner (PBC) 14.

The optical phase modulator depicted provides a pure phase modulation to the optical carrier. An electro-optic device can be used where the optical phase shift of the optical beam is linearly proportional to the applied RF voltage, V_{S}(t), as follows

φ_{S}πV_{S}(t)/V_{π},

where V_{π} is the half-wave voltage of the phase modulator. A single waveguide low-loss and wideband phase modulator for chirp control or coherent optical applications produced by EOSpace, Inc., Redmond, Wash.

FIG. 3 depicts another embodiment of the RF-to-optical conversion unit 1 where polarization-maintaining (PM) optical fibers are used. PANDA type PM fibers are shown as an example. The converter is similar to the previous one except that the half-wave plate is eliminated. This is achieved by orienting the direction of the stress rod of the PM fiber connecting to the PBC in the lower branch 15 by 90° from that of the upper branch. A single optical beam with an orthogonal polarized signal and reference optical carriers is produced at the output.

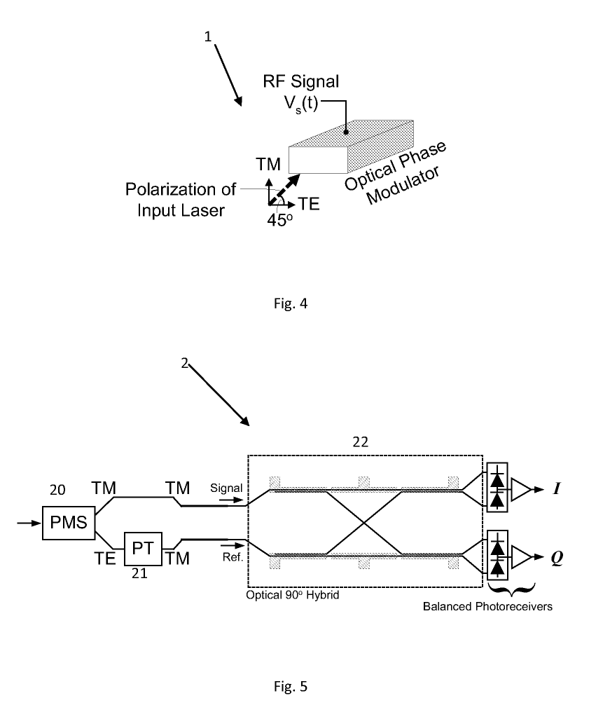

A preferred embodiment of the RF-to-optical conversion unit 1 is shown in FIG. 4. The input laser is launched at a 45° angle relative to the optical axis of the phase modulator, TM for example. The laser field can therefore be decomposed into the two orthogonal components, TM and TE, parallel and perpendicular to the optical axis of the modulator. For optical phase modulators that exhibit the linear electro-optic effect, e.g., lithium niobate, the applied voltage only affects the optical beam polarized along the optical axis of the modulator, TM in this case. The phase modulator imparts a time-varying phase shift on the TM optical beam traversing along the modulator according to the RF drive signal as follows

φ_{S}=πV_{S}(t)/V_{π}.

The laser beam component polarized in the TE direction propagating into the modulator is not affected by the RF voltage. Therefore, a single laser beam with orthogonally polarized modulated and unmodulated optical carrier is obtained at the output of the modulator.

The electro-optic phase modulator includes an optical waveguide and RF electrodes. In one embodiment, the optical waveguide is a lithium niobate material. In another embodiment the optical waveguide is a semiconductor material. Yet in another embodiment, the optical waveguide is a polymer material, but can be any suitable optical waveguide material or architecture known in the art. The RF input signal is applied to the electrode that creates an electric field across the waveguide. The electric field in the waveguide changes the refractive index of the waveguide that affects the propagation speed of an optical carrier signal propagating down the waveguide. Therefore, the carrier signal is modulated by the RF input signal. The known modulators were designed so that the same amount of phase modulation occurred for all of the frequencies over the operational range.

At the receiver, the optical signal is collected and directed to a coherent demodulator 2 shown in FIG. 1. The coherent demodulator 2 is composed of three key elements depicted in FIG. 5: a polarization mode splitter (PMS) 20, a polarization transformer (PT) 21, and an optical 90° hybrid 22. The input optical beam is first separated into the TM and TE components correspond to the modulated and unmodulated carrier via the polarization mode splitter 20. The polarization mode splitter divides the TM and TE polarization into two separate waveguides. The splitter device is well known in the art of waveguide device as described for example in U.S. Pat. No. 5,151,957 by L. Riviere. The polarization of the unmodulated carrier is then converted to TM via the polarization transformer 21 so that both optical beams have the same polarization state at the input of the optical 90° hybrid 22. The polarization transformer is well known in the art of waveguide device as described for example in U.S. Pat. No. 4,384,760 by R. C. Alferness. The two optical signals are directed to the optical 90° hybrid where the two optical beams are combined in quadrature before balanced detection. Detail operation of the optical 90° hybrid can be found in U.S. patent application Ser. No. 11/679,376 by the same team of inventors, which is fully incorporated herein by reference.

In contrast to conventional coherent detection scheme where a local laser and an OPLL is required to track and cancelled the laser phase noise, the embodiment of the coherent demodulator of the present invention does not require a local laser or an OPLL, thus reducing cost and complexity. Initial adjustment or active control of the polarization mode splitter, the polarization transformer, and the optical 90° hybrid can be achieved by transmitting a known pilot tone or training signal periodically or as needed in respond to the transmission channel.

A preferred embodiment of the coherent demodulator is a monolithic integrated device with the polarization mode splitter, the polarization transformer, and the optical 90° hybrid connected via optical waveguides on a single substrate of, e.g., lithium niobate. Other materials that exhibit electro-optic effect with low optical losses are also included. Integration is preferred because it provides a compact and robust device.

The optical 90° hybrid shown in FIG. 5 has two input optical ports that accept the signal and reference and four optical output ports that connect to two sets of balanced photoreceivers. The six-port optical 90° hybrid configuration is superior where it provides the necessary optical outputs for balanced detection as well as the in-phase and quadrature-phase outputs. Balanced detection has the advantage of removing the dc component of the signal and it provides a gain of factor of two for the modulated signal amplitude compared with single-ended detection.

Another preferred embodiment of the coherent demodulator is a hybrid integration of the three optical elements with the two sets of balanced photoreceivers in a single package. This eliminates connecting optical fibers between the outputs of the optical 90° hybrid and the balanced photoreceivers which further reduces the footprint of the coherent demodulator. An example of the hybrid integration is described in details in U.S. patent application Ser. No. 11/695,920 by the same team of inventors.

The electrical outputs of the two sets of balanced photoreceivers are I=k cos(φ_{S}) and Q=k sin(φ_{S}), where k is a real number depends on the responsivity of the photodetector and the optical powers of the signal and reference laser beam. The two signals are then directed to the signal recovery unit where both signals are digitized simultaneously via the analog/digital converters shown in FIG. 1. The sampled signals are processed in the digital signal processing unit. The process of extracting the RF signal, V_{S}(t), is described next.

The sampled I and Q signals can be combined and expressed in a complex form

C=I+iQ=ke^{iφ}^{_{S}}.

It follows that the phase modulation can be computed via

φ_{S}=arg(C),

where arg(c) is the argument or phase angle of the complex number C. The phase modulation can also be computed using φ_{S}=Im{ln(C/k)}. Recall that the phase modulation is related to the RF signal via

φ_{S}=πV_{S}(t)/V_{π}.

Therefore, the RF signal can be recovered using the relation

V_{S}(t)=arg(C)V_{π}/π,

or

V_{S}(t)=Im{ln(C/k)}V_{π}/π.

A digital/analog converter can be used to obtain the recovered analog RF signal. Phase jumps due to |φ_{S}|>π can be avoided via phase unwrapping by adding multiples of ±2π when absolute jumps occur. Alternatively, the gain of the RF amplifier, G, shown in FIG. 1 can be adjusted according to V_{π} and the maximum value of the input RF signal or max {|Vᵢ(t)|} such that |φ_{S}|≦π. As a result, one obtain G≦V_{π}/max {|Vᵢ(t)|}.

The digital signal processing unit offers many more applications and flexibilities than just extracting the RF signal described above. For example, post-compensation of the signal can be applied using DSP to compensate distortion due to the channel, the transmitter, or the receiver.

For atmospheric transmission where turbulence gives rise to optical power fade at the receiver, adaptive optics at the receiver can be used to mitigate the fading. Since the turbulence speed (at least ms) is much slower than the RF signal speed (˜microsecond) no degradation of the phase-modulated optical signal is expected.

An embodiment of the present invention that addresses impairment of the transmission channel such as multi-path effect on the analog RF photonic system is described. For application where the multi-path effect is significant such as in multi-mode fiber transmission or scattering in atmospheric line-of-sight or non-line-of-sight transmission, multi-carrier approach can be utilized to mitigate the multi-path effect. Orthogonal frequency division multiplexing or OFDM encode information on many lower speed sub-carriers. OFDM signaling is therefore very robust to multi-path and dispersion impairments. The details of OFDM communications are disclosed in U.S. patent application Ser. No. 12/045,765 by the same team of inventors.

OFDM encoded with RF signal modulation can be readily applied to the optical phase modulator as depicted in the embodiment shown in FIG. 1 where Vᵢ(t) in this case represents an OFDM signal with the RF signal encoded onto the subcarriers. At the receiver, the RF signal can be recovered from the orthogonal subcarriers in the same manner as described earlier with additional signal processing such as Fast Fourier Transform operating on the subcarriers which can be conveniently performed in the digital signal processing domain already part of the signal recovery unit shown in FIG. 1.

What is claimed is:

1. A signal transmission system, comprising:
a phase modulator which modulates a first portion of a light beam with a RF or microwave input signal to produce a phase modulated optical signal; the first portion of the light beam having a first polarization state;
the first portion of the light beam being transmitted to a receiver along with a second portion of the light beam; the second portion of the light beam having a second polarization state being orthogonal to the first polarization state; and
a receiver which aligns the polarization states of the beam portions and mixes incoming the first and the second portions of the light beam producing output mixed beams that are detected by a set of photodiodes followed by a digital signal processing (DSP) unit; the DSP unit outputting an output signal for further processing or display.

2. The system of claim 1, wherein the receiver includes an interferometer for mixing the first and the second portion of the light beam.

3. The system of claim 2, wherein the interferometer is a 90-degrees optical hybrid.

4. The system of claim 3, wherein the 90-degrees optical hybrid outputting four optical signals being detected by the set of photodiodes outputting I (in-phase) and Q (quadrature-phase) electrical signals.

5. The system of claim 1, wherein the set of photodiodes comprises two pairs of balanced photodetectors.

6. The system of claim 1, wherein the phase modulator is a single waveguide optical modulator.

7. The system of claim 1, wherein the phase modulator performs linear modulation by introducing an optical phase shift to the optical beam linearly proportional to the RF or microwave applied voltage.

8. The system of claim 1, further comprising a half-wave (λ/2) plate for polarization rotation of the second portion of the light beam to make the second portion orthogonal to the first portion of the light beam.

9. The system of claim 1, further comprising a polarization beam combiner to combine the first and second portions of the light beam prior to transmitting them to the receiver.

10. The system of claim 1, further comprising a laser producing an initial optical beam, the initial optical beam forming the first and the second portions of the light beam.

11. The system of claim 10, wherein the initial undivided optical beam enters the phase modulator having a polarization state at a 45° angle relative to the optical axis of the optical phase modulator.

12. The system of claim 10, wherein the initial optical beam is split into the first portion and the second portion propagating in a first and a second polarization-maintaining (PM) optical fibers respectively, wherein the directions of the stress rod of the first and the second PM fibers differ by 90°.

13. The system of claim 1, wherein the receiver includes a polarization beam splitter to separate the first and the second portions of the light beam and a polarization rotator to align the polarization states of the first and the second portions of the light beam.

14. The system of claim 1, wherein the first portion of the light beam comprises OFDM (orthogonal frequency division multiplexed) signal with a plurality of orthogonal frequency subcarriers encoded with the RF or microwave signal using the phase modulator, and the DSP unit performs Fast Fourier Transformer operation to separate the frequency subcarrier signals and recover RF and microwave signal from each subcarrier.

15. A method of a RF or microwave photonic transmission, comprising:
phase modulating a first portion of a light beam with the RF or microwave input signal to produce a phase modulated optical signal; the first portion of the light beam having a first polarization state;
transmitting the first portion of the light beam to a receiver along with a second portion of the light beam; the second portion of the light beam having a second polarization state being orthogonal to the first polarization state;
aligning the polarization states of the beam portions at the receiver side;
mixing the first and the second portions of the light beam producing output mixed beams that are detected by a set of photodiodes; and
processing electrical signals from the photodiodes in a digital signal processing (DSP) unit; the DSP unit outputting an output signal for further processing or display.

16. The method of claim 15, wherein phase modulating is linearly dependent on the RF or microwave signal.

17. The method of claim 15, wherein mixing the first and the second portions of the light beam is in an interferometer.

18. The method of claim 17, wherein the interferometer is a 90-degrees optical hybrid outputting four optical signals being detected by the set of photodiodes outputting I (in-phase) and Q (quadrature-phase) electrical signals.

19. The method of claim 18, wherein the set of photodiodes consists of two pairs of balanced photodetectors.

20. The method of claim 15, wherein the media between the transmitter and the receiver is selected from fiber, free space, air or water.
